(19) United States
(12) Patent Application Publication
(10) Pub. No.: US 2022/0171642 A1
(43) Pub. Date: Jun. 2, 2022

(54) SCRIPT-BASED EMULATION OF DEVICES

(71) Applicant: Hewlett-Packard Development Company, L.P., Spring, TX (US)

(72) Inventors: Hsiang-Ta Ke, Taipei City (TW); Chih-Heng Lai, Taipei City (TW)

(73) Assignee: Hewlett-Packard Development Company, L.P., Spring, TX (US)

(21) Appl. No.: 17/601,718

(22) PCT Filed: Aug. 5, 2019
(86) PCT No.: PCT/US2019/045046

§ 371 Date: Oct. 6, 2021

(51) Int. Cl. G06F 9/455; G06F 11/27; G06F 13/42

(52) U.S. Cl. CPC G06F 9/455; G06F 2213/0042; G06F 13/4282; G06F 11/27

(57) ABSTRACT

In one example, an electronic device may include an interface to communicate with a port of an in-test device, a chipset, and an emulation controller. The emulation controller may receive a descriptor associated with a device being emulated, retrieve a script corresponding to the descriptor, and execute the script to enable the chipset to emulate a function of the device. The emulation controller may operate the emulated device according to the script to generate a response message to a query from the in-test device and transmit the response message to the in-test device.

### BACKGROUND

Computing devices may connect with peripheral devices such as mice, keyboards, printers, speakers, scanners, microphones, removable data storages, web cameras, and the like using interface protocols that enable communication with the peripheral devices. The peripheral devices can be physically connected to the computing device using a cable or other wired connection over which input data from the peripheral devices and/or output data to the peripheral devices is transferred. Examples of such interface protocols may include Universal Serial Bus (USB), FireWire (IEEE 1394), the Thunderbolt bus provided by Apple® Inc., PCI Express®, and the like.

### BRIEF DESCRIPTION OF THE DRAWINGS

Examples are described in the following detailed description and in reference to the drawings, in which:

FIG. 1A is a block diagram of an example electronic device, including an emulation controller that executes a script to enable a chipset to emulate a function of a device;

FIG. 1B is a block diagram of the example electronic device of FIG. 1A, depicting additional features;

FIG. 2 is a block diagram of an example electronic device, including an emulation controller that executes a script to enable a USB chipset to emulate a function of a USB device based on an operating mode of a dual-role controller;

FIG. 3A illustrates an example architecture to execute a script to enable a chipset to emulate a function of a device;

FIG. 3B is an example script interface, depicting a feature that enables to select and write a script;

FIG. 3C is an example graphical user interface, depicting a script command feature that enables to write script commands in a scripting language; and

FIG. 4 is a block diagram of an example electronic device including a non-transitory machine-readable storage medium, storing instructions to execute a script to simulate interactions of a USB device.

### DETAILED DESCRIPTION

The peripheral devices (also referred to as client devices) can be physically connected to computing devices using cables or other wired connections over which input data from the peripheral devices and/or output data to the peripheral devices is transferred. Computing devices may use interface protocols to enable communication with the peripheral devices. Examples interface protocol may include Universal Serial Bus (USB). However, the computing devices may experience protocol issues during a new peripheral device (e.g., a USB client device) design. Particularly, encrypted protocols may be difficult to validate a correct timing or a command sequence as the peripheral devices are provided with embedded program or firmware. When there is a change in the program or firmware, the updated program or firmware may need to be compiled and then downloaded into the peripheral device. Debugging in such a manner may be time consuming. Also, setting up a firmware debug environment and then debugging the firmware may be complex.

In such scenarios, the computing devices and the interactions with the peripheral devices may be tested to determine whether the computing device is working correctly. Tests should verify how a computing device or system under test may respond to the peripheral devices and may also verify that applications and/or computing devices, which involve specific peripheral devices, function properly. To test and verify a computing device's interaction with the peripheral devices, manual data entry and verification procedures may be performed for each peripheral device that can be connected to the computing device. Entries may be manually performed for each peripheral device because each peripheral device may present itself with unique USB identifications and simple interface tests may not verify specific features of each peripheral device. Furthermore, when testing a computing device or an application that involves specific USB peripheral devices, such as special keyboards, manual testing and validation may be performed using the computing device. Such testing methods may prone to errors and may have to be repeated to ensure accuracy.

The process of designing, implementing, and testing new hardware and programs, such as computing devices, peripheral devices, mobile devices, and other types of devices, and the associated programs or applications such as operating systems and device drivers, can involve the use of simulations of the devices being developed. Some example scenarios may use a device that emulates or simulates behavior and operations of another device. One such scenario may include testing of a new and yet unavailable target device under development, such as printers, multifunctional peripherals (MFPs), peripherals, digital cameras, USB mouse, USB keyboard, and the like. The number of such new devices being developed may be constantly increasing, and may need shorter and efficient development and testing cycles. If an existing device can be made to emulate a target device, then installation and other testing can begin without waiting for completion of the target device.

Examples described herein may provide an electronic device (e.g., a general-purpose computing device) including a controller that executes a script to emulate a device (e.g., a USB device) and generate response messages that test an in-test device (i.e., a device under test) with the emulated device according to the script. Thus, examples described herein may enable debugging and validation of the USB devices with the in-test device. The script may include a set of script commands generated using a scripting language such as Python. For example, when the script is executed to emulate a target device, a script command may be aimed at preparing or modifying a response to be returned to the in-test device. The response may be generated using script codes. Such scripts can be executed to set the emulated device in a state, such that the emulated device can respond to incoming queries/commands in a defined manner.

Further, the electronic device may include a dual-role controller that operates the electronic device in a USB host mode or a USB client mode. The dual-role controller may enable to test host-side features of the in-test device or client-side features of the in-test device. For testing a USB client device under test with a USB host device, examples described herein may execute a script to enable the USB chipset to emulate the USB host device by operating the dual-role controller of the computing device in the USB host mode. For testing a USB host device under test with a USB client device, examples described herein may execute a script to enable a USB chipset to emulate the USB client device by operating the dual-role controller of the computing device in the USB client mode.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

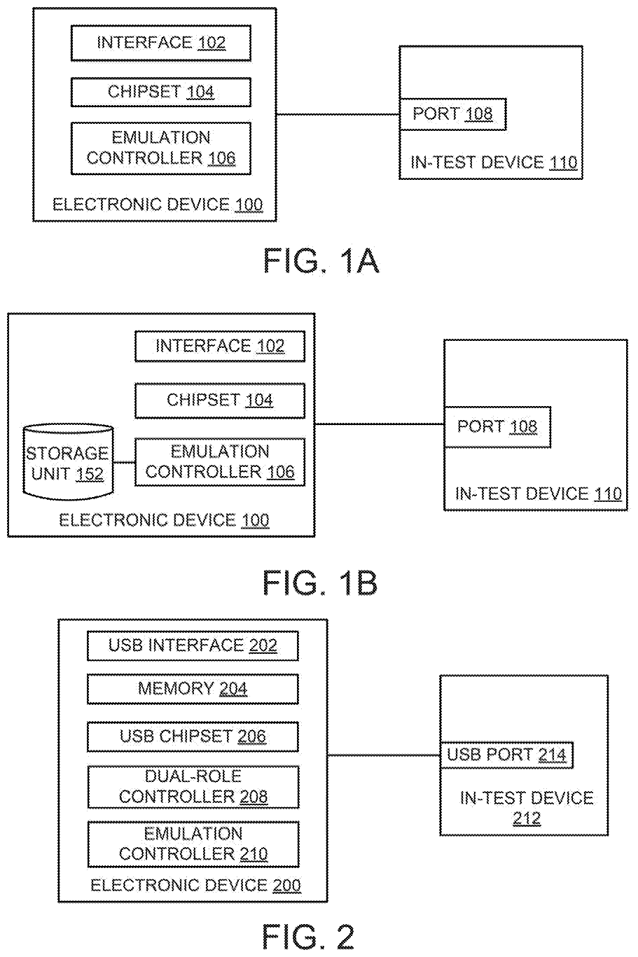

Turning now to the figures, FIG. 1A is a block diagram of an example electronic device 100, including an emulation controller 106 to execute a script to enable a chipset 104 to emulate a function of a device. Device emulation may enable installation and/or testing of a new and yet unavailable target device under development. As used herein, the term “electronic device” may represent, but is not limited to, a personal computer (PC), a server, a notebook, a tablet, a smartphone, a personal digital assistant, or any general-purpose computing device.

Electronic device 100 may include an interface 102, chipset 104, and emulation controller 106 that are communicatively coupled with each other. Interface 102 may be used to communicate with a port 108 of an in-test device 110. Interface 102 may permit electronic device 100 to communicate with in-test device 110. Example interface 102 may include a cable or other wired connection such as a Universal Serial Bus (USB) interface to communicate with port 108 (e.g., a USB port) of in-test device 110. In other examples, interface 102 may include FireWire (IEEE 1394), the Thunderbolt bus provided by Apple® Inc., PCI Express®, and the like.

In some examples, components of electronic device 100 may be implemented in hardware, machine-readable instructions, or a combination thereof. In one example, emulation controller 106 may be implemented as an engine or a module including any combination of hardware and programming to implement the functionalities described herein.

During operation, emulation controller 106 may receive a descriptor associated with the device being emulated. In one example, the device being emulated may be a host device (e.g., personal computer) or a client device (e.g., a USB mouse). In some examples, a set of descriptors may be stored in a register associated with emulation controller 106 and the descriptor associated with the device may be selected from the set of descriptors via a user interface. The device descriptors may be data structures in electronic device 200 that describe device capabilities and how these capabilities can be used.

In other examples, a default set of descriptors may be provided in electronic device 200. The default set of descriptors may be stored in a memory (e.g., storage unit 152 as shown in FIG. 1B) of electronic device 200. The set of descriptors can be configurable, for instance, to add a new descriptor, remove an existing descriptor, modify an existing descriptor, and the like.

Further, emulation controller 106 may retrieve the script corresponding to the descriptor. In one example, the script may include a set of script commands generated/written using an interpretable scripting language. The scripts can be configurable via the user interface of electronic device 100.

Example interpretable scripting language may be Python, Per, Command line interface, Shell scripts, tool command language (TCL), Bash, PHP (Personal Home Page or PHP: Hypertext Protocol), and the like. For example, Python may be an open source script engine and can be used for writing the scripts. In some examples, the script of USB devices may be associated with different kinds of USB descriptors, for example, device descriptor, Human Interface Device (HID) descriptor, and the like. The descriptors may mention a function and protocol timing design of the communication. Example descriptors may include a USB mouse descriptor, a USB keyboard descriptor, a finger printer descriptor, a USB webcam device, a USB touchpad descriptor, and the like. The following may be an example of USB touchpad descriptor:

| 0x85, REPORTID_TOUCHPAD, | // REPORT_ID (Touchpad) |
|---|---|
| 0x09, 0x22, | // USAGE (Finger) |
| 0xa1, 0x02, | // COLLECTION (Logical) |
| 0x15, 0x00, | // LOGICAL_MINIMUM ( 0) |
| 0x25, 0x01, | // LOGICAL_MAXIMUM (1) |
| 0x09, 0x47, | // USAGE (Confidence) |
| 0x09, 0x42, | // USAGE (Tip switch) |
| 0x95, 0x02, | // REPORT_COUNT (2) |
| 0x75, 0x01, | // REPORT_SIZE (1) |
| 0x81, 0x02, | // INPUT (Data Var,Abs) |
| . . . | |
| 0x81, 0x02, | // INPUT (Data,Var,Abs) |
| 0xc0, | // END_COLLECTION |

Furthermore, emulation controller 106 may execute the script to enable chipset 104 to emulate a function of the device. Also, emulation controller 106 may operate the emulated device according to the script to generate a response message to a query from in-test device 110 and transmit the response message to in-test device 110.

In one example, emulation controller 106 may parse the script to obtain a set of script commands, and execute script actions corresponding to the script commands to enable chipset 104 to emulate the function of the device and generate the response message to the query/command from in-test device 110. The response message may be specified in a form dictated by the scripting language. Thus, the script may configure chipset 104 to be a specific firmware to emulate a function of the device (e.g., a target USB host/client device).

FIG. 18 is a block diagram of example electronic device 100 of FIG. 1A, depicting additional features. For example, similarly named elements of FIG. 1B may be similar in structure and/or function to elements described with respect to FIG. 1A. As shown in FIG. 1B, electronic device 100 may include a storage unit 152 to store a plurality of descriptors with identification information related to different devices being emulated. In-test device 110 may contain a device driver. Port 108 may monitor for any new device attachment on the USB lines. Once an attachment is detected, port 108 may notify in-test device 110. This will result in in-test device 110 performing the enumeration to select a correct device driver. In-test device 110 may then load the selected device driver using the configuration received from the selected descriptors.

Further, storage unit 152 may store a plurality of scripts corresponding to the plurality of descriptors. Each script may enable chipset 104 to emulate a function of a different device and generate a corresponding response message in a form specified by each script. Since the scripts can be configurable, emulation controller 106 can use chipset 104 of electronic device 100 to emulate different devices (e.g., USB client/host devices) to test completability of a new USB client/host device with in-test device 110.

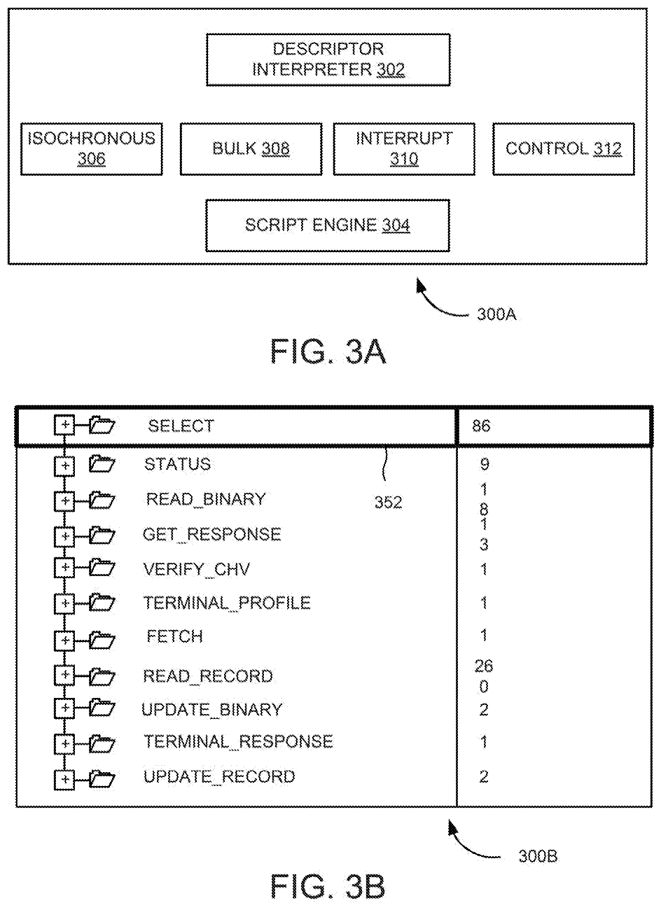

FIG. 2 is a block diagram of an example electronic device 200, including an emulation controller 210 to execute a script to enable a USB chipset 206 to emulate a function of a USB device based on an operating mode of a dual-role controller 208. Electronic device 200 may include a USB interface 202, memory 204, USB chipset 206, dual-role controller 208, and emulation controller 210 that are communicatively coupled with each other.

Further, USB interface 202 may enable electronic device 200 to communicate with a USB port 214 of an in-test device 212 (i.e., a computing device under test or a peripheral device under test). Further, memory 204 may store a plurality of descriptors (e.g., USB descriptors) and corresponding scripts, for instance, written in a scripting language. For example, a descriptor may include information about a USB device, associated configurations, interfaces, and/or related endpoints. Example information may include class information, vendor and product identifiers, number of configurations, and the like. Descriptors may define a USB profile and may be loaded into electronic device 200 or emulation controller 210. Furthermore, dual-role controller 208 may operate electronic device 200 in a USB host mode or a USB client mode. In this example, dual-role controller 208 may enable electronic device 200 to designate itself as the USB host device or the USB client device.

During operation, emulation controller 210 may receive a selection of a descriptor associated with the USB device being emulated. In one example, the USB device being emulated may be a USB host device such a personal computer (PC), a server, a notebook, a tablet, a smartphone, a personal digital assistant, and the like. In another example, the USB device being emulated may be a USB client device such as a USB mouse, a USB keyboard, a finger printer scanner, a USB touchpad, a printer, and the like.

Further, emulation controller 210 may retrieve a script corresponding to the descriptor. Furthermore, emulation controller 210 may execute the script to enable USB chipset 206 to emulate a function of the USB device by using dual-role controller 208. Emulation controller 210 may implement USB on the go so that electronic device 200 can act as a peripheral/client device in the USB client mode or a host end of a USB device in the USB host mode.

In one example, in-test device 212 may be a USB host device under test, and the USB device being emulated may be a USB client device. In-test device 212, in this example, may be a gaming device being developed for use with a wide array of USB client devices (i.e., USB peripheral devices). In this example, emulation controller 210 may execute the script to enable USB chipset 206 to emulate the function of the USB client device by operating dual-role controller 208 in the USB client mode in order to test a behaviour of the USB host device under test (e.g., in-test device 212) with the USB client device. Examples described herein may be suited for device drivers, such as USB mouse drivers, USB keyboard drivers, printer drivers, and the like.

In another example, in-test device 212 may be a USB client device under test, and the USB device is a USB host device. In this example, emulation controller 210 may execute the script to enable USB chipset 206 to emulate the function of the USB host device by operating dual-role controller 208 in the USB host mode in order to test a behaviour of the USB client device under test (i.e., in-test device 212) with the USB host device.

Further, emulation controller 210 may control the function of the emulated USB device (e.g., electronic device 200) according to the script to generate a response message to a query from in-test device 212 and transmit the response message to in-test device 212. In one example, emulation controller 210 may detect commands/queries coming from in-test device 212 into USB Interface 202. At the same time, emulation controller 210 may organize the responses to in-test device 212 according to the script. Emulation controller 210 may enable USB chipset 206 to emulate the USB device to communicate to in-test device 212 using USB protocol specifications.

Thus, using advantage of USB protocol specifications, the emulated USB device may serve as a test jig for the installation and setup of the peripheral devices. Installation and setup of the peripheral devices may be done during the configuration and set-up protocol of the USB device. If the emulated USB device meets requirements for the device configuration and setup, in-test device 212 can be made to believe that the emulated USB device is the actual USB device with the functionality ready for utilization. In other words, a USB device can be seen by a USB host controller of in-test device 212 as an operational device during initialization as long as the USB device gives the correct replies to in-test device 212.

Electronic device 100 of FIGS. 1A and 1B or 200 of FIG. 2 may include computer-readable storage medium having (e.g., encoded with) instructions executable by a processor to implement respective functionalities described herein in relation to FIGS. 1A, 1B, and 2. In some examples, the functionalities described herein, in relation to instructions to implement functions of components of electronic device 100 or 200 and any additional instructions described herein in relation to the storage medium, may be implemented as engines or modules including any combination of hardware and programming to implement the functionalities of the modules or engines described herein. The functions of components of electronic device 100 or 200 may also be implemented by a respective processor. In examples described herein, the processor may include, for example, one processor or multiple processors included in a single device or distributed across multiple devices.

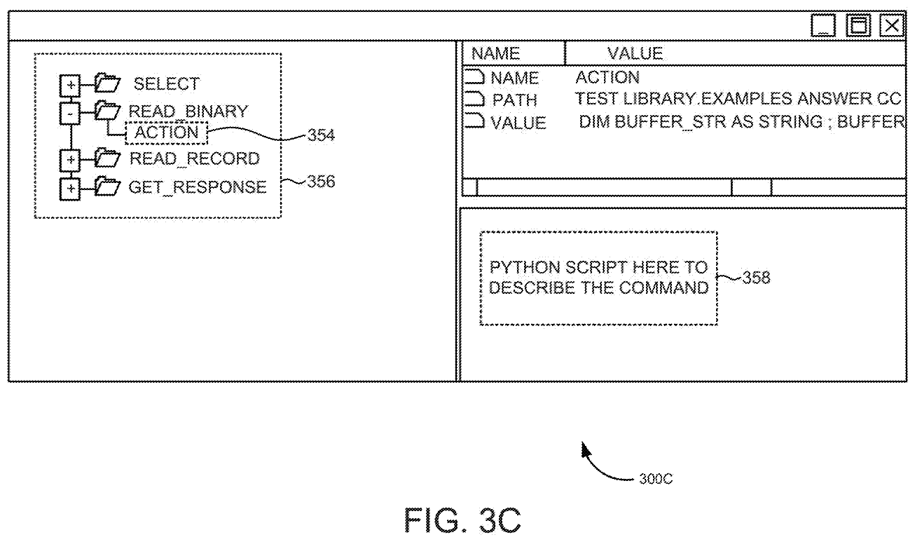

FIG. 3A illustrates an example architecture 300A to execute a script to enable a chipset to emulate a function of a device. As shown in FIG. 3A, example architecture 300A may depict different types of data transfers, such as an isochronous transfer 306, a bulk transfer 308, an interrupt transfer 310, and a control transfer 312 according to USB specification, to communicate data across a USB.

For example, isochronous transfer 306 may be used for transfers that need to be performed in real-time and data may be transferred at a rate corresponding to a timing mechanism. Bulk transfer 308 may be used for a periodic transfer of significantly large data. Interrupt transfer 310 may be used to transfer periodic and low-bandwidth data, which may have priority over other requests. Control transfer 312 may be used to transfer information for controlling, configuring USB peripheral/client devices, and checking a status of the USB device.

The peripheral/client devices may achieve optimal communication by selecting an appropriate method of data transfer. For example, to build a specific function of a USB mouse device, the following components may be selected in the electronic device:

1. A USB mouse descriptor via a user interface.

2. Interrupt transfer 310 and control transfer 312.

3. Specific “command set” to define in the script.

The USB mouse descriptor may be inputted via a user interface through interrupt transfer 310 and control transfer 312. Example architecture 300A may further include a descriptor interpreter 302 and a script engine 304. In one example, descriptor interpreter 302 and script engine 304 may be implemented as engines or modules including any combination of hardware and programming to implement the functionalities described herein.

During operation, descriptor interpreter 302 may provide information derived from the USB mouse descriptor. Further, script engine 304 may retrieve a script corresponding to the information derived from the USB mouse descriptor, parse the script to obtain a set of script commands, and execute script actions corresponding to the script commands to emulate the function of the device and generate the response message to the query from an in-test device.

FIG. 3B is an example script interface 300B, depicting a feature 352 that enables to select and write a script. As shown in FIG. 31, feature 352 may be selected via script interface 300B to define scripts corresponding to the descriptors in a scripting language. Upon selecting feature 352, a graphical user interface may be provided to define the commands in the scripting language as shown in FIG. 3C.

FIG. 3C is an example graphical user interface 3000, depicting a script command 354 written using the scripting language (e.g., Python). Particularly, FIG. 3C depicts a set of script commands 356 corresponding to various target devices being emulated. Script command 354 in set of script commands 356 may be defined using an input area 358 of graphical user interface 3000. Input area 358 may enable to define or write the script corresponding to descriptors using the scripting language. The defined script commands may be inputted to script engine 304 of FIG. 300A via graphical user interface 3000.

When the script is executed to emulate a target device, the scripts may be aimed at preparing or modifying a response to be returned to an in-test device. The response may be generated using script codes. Such scripts can be executed to set the emulated device in a state, such that the emulated device can respond to incoming queries/commands in a defined manner.

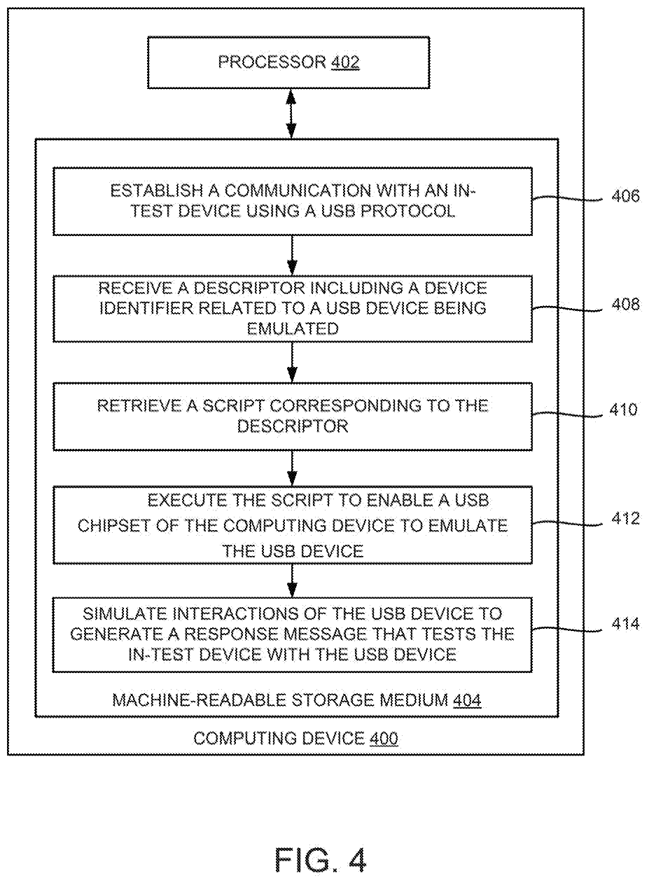

FIG. 4 is a block diagram of an example computing device 400 including a non-transitory machine-readable storage medium 404, storing instructions to execute a script to simulate interactions of a USB device. Computing device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to computing device 400.

As shown in FIG. 4, machine-readable storage medium 404 may store instructions 406-414. In an example, instructions 406-414 may be executed by processor 402 to execute the script to simulate interactions of the USB device. Instructions 406 may be executed by processor 402 to establish a communication with an in-test device using a USB protocol.

Instructions 408 may be executed by processor 402 to receive a descriptor including a device identifier related to a USB device being emulated. Instructions 410 may be executed by processor 402 to retrieve a script corresponding to the descriptor.

Instructions 412 may be executed by processor 402 to execute the script to enable a USB chipset of computing device 400 to emulate the USB device. In this example, instructions to execute the script may include instructions to parse the script to obtain a set of script commands and execute script actions corresponding to the script commands to enable the USB chipset to emulate the USB device and generate the response message.

In one example, the in-test device may be a USB host device under test and the USB device may be a USB client device. In this example, instructions to execute the script may include instructions to execute the script to enable the USB chipset to emulate the USB client device by operating a dual-role controller of computing device 400 in a USB client mode in order to test the USB host device under test with the USB client device.

In another example, the in-test device may be a USB client device under test, and the USB device may be a USB host device. In this example, instructions to execute the script may include instructions to execute the script to enable the USB chipset to emulate the USB host device by operating a dual-role controller of computing device 400 in a USB host mode in order to test the USB client device under test with the USB host device.

Instructions 414 may be executed by processor 402 to execute the script to simulate interactions of the USB device to generate a response message that tests the in-test device with the USB device. In one example, instructions to simulate interactions of the USB device may include instructions to receive a query from the in-test device, generate the response message to the query according to the script, and transmit the response message to the in-test device to enable testing the in-test device with the USB device.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
an interface to communicate with a port of an in-test device;
a chipset; and
an emulation controller to:
receive a descriptor associated with a device being emulated;
retrieve a script corresponding to the descriptor;
execute the script to enable the chipset to emulate a function of the device; and
operate the emulated device according to the script to:
generate a response message to a query from the in-test device; and
transmit the response message to the in-test device.

2. The electronic device of claim 1, wherein the script comprises a set of script commands generated using an interpretable scripting language.

3. The electronic device of claim 1, wherein the interface is a Universal Serial Bus (USB) interface to communicate with a USB port of the in-test device, and wherein the device being emulated is a USB device.

4. The electronic device of claim 1, wherein the emulation controller is to:
parse the script to obtain a set of script commands; and
execute script actions corresponding to the script commands to enable the chipset to emulate the function of the device and generate the response message to the query from the in-test device.

5. The electronic device of claim 1, further comprises:
a storage unit to store a plurality of descriptors with identification information related to different devices being emulated, and to store a plurality of scripts corresponding to the plurality of descriptors, each script is to enable the chipset to emulate a function of the different devices and generate a corresponding response message in a form specified by each script.

6. An electronic device comprising:
a Universal Serial Bus (USB) interface to communicate with a USB port of an in-test device;
a memory to store a plurality of descriptors and corresponding scripts;
a USB chipset;
a dual-role controller to operate the electronic device in a USB host mode or a USB client mode; and
an emulation controller to:
receive a selection of a descriptor associated with a USB device being emulated;
retrieve a script corresponding to the descriptor;
execute the script to enable the USB chipset to emulate a function of the USB device by using the dual-role controller; and
control the function of the emulated USB device according to the script to:
generate a response message to a query from the in-test device; and
transmit the response message to the in-test device.

7. The electronic device of claim 6, wherein the in-test device is a USB host device under test, and the USB device is a USB client device.

8. The electronic device of claim 7, wherein the emulation controller is to:
execute the script to enable the USB chipset to emulate the function of the USB client device by operating the dual-role controller in the USB client mode in order to test a behaviour of the USB host device under test with the USB client device.

9. The electronic device of claim 6, wherein the in-test device is a USB client device under test, and the USB device is a USB host device.

10. The electronic device of claim 9, wherein the emulation controller is to:
execute the script to enable the USB chipset to emulate the function of the USB host device by operating the dual-role controller in the USB host mode in order to test a behaviour of the USB client device under test with the USB host device.

11. A non-transitory computer-readable storage medium encoded with instructions that, when executed by a computing device, cause the computing device to:
establish a communication with an in-test device using a USB protocol;
receive a descriptor including a device identifier related to a USB device being emulated;
retrieve a script corresponding to the descriptor; and
execute the script to:
enable a USB chipset of the computing device to emulate the USB device;
simulate interactions of the USB device to generate a response message that tests the in-test device with the USB device.

12. The non-transitory computer-readable storage medium of claim 11, wherein instructions to simulate interactions of the USB device comprise instructions to:
receive a query from the in-test device;
generate the response message to the query according to the script; and
transmit the response message to the in-test device to enable testing the in-test device with the USB device.

13. The non-transitory computer-readable storage medium of claim 11, wherein instructions to execute the script comprise instructions to:
parse the script to obtain a set of script commands; and
execute script actions corresponding to the script commands to enable the USB chipset to emulate the USB device and generate the response message.

14. The non-transitory computer-readable storage medium of claim 11, wherein the in-test device is a USB host device under test and the USB device is a USB client device, and wherein instructions to execute the script comprise instructions to:
execute the script to enable the USB chipset to emulate the USB client device by operating a dual-role controller of the computing device in a USB client mode in order to test the USB host device under test with the USB client device.

15. The non-transitory computer-readable storage medium of claim 11, wherein the in-test device is a USB client device under test, and the USB device is a USB host device, and wherein instructions to execute the script comprise instructions to:
execute the script to enable the USB chipset to emulate the USB host device by operating a dual-role controller of the computing device in a USB host mode in order to test the USB client device under test with the USB host device.
